(19) United States
(12) Patent Application Publication
(10) Pub. No.: US 2021/0262696 A1
(43) Pub. Date: Aug. 26, 2021

(54) ELECTRIC HEATER FOR TANK

(71) Applicant: I.R.C.A. S.P.A. INDUSTRIA RESISTENZE CORAZZATE E AFFINI, VITTORIO VENETO31029 (IT)

(72) Inventors: Federico ZOPPAS, Treviso (IT); Stefano ZANELLA, Montebelluna (IT); Mario EUSEBIO, Pordenone (IT); Andrea PRADAL, Oderzo (IT)

(21) Appl. No.: 17/260,679

(22) PCT Filed: Jul. 19, 2019
(86) PCT No.: PCT/IB2019/056197

§ 371 Date: Jan. 15, 2021

(30) Foreign Application Priority Data
Jul. 19, 2018 (IT) 102018000007346

(51) Int. Cl. F24H 1/20; H05B 3/82; H05B 1/02

(52) U.S. Cl. CPC F24H 1/202; H05B 3/82; H05B 2203/021; H05B 1/0244; H05B 1/0236

(57) ABSTRACT

An electric heater (1), in particular for heating, in particular thawing, an aqueous solution comprising urea inside a tank (100) to save fuel and abate pollution of a motor vehicle, the electric heater (1) comprising—a thermally conductive body (20), provided with a wall (23) which at least partially extends about an axis (Z), comprising two opposite faces (21, 22); a plurality of fins (24, 25) which extend transversally from at least a first face (21) of said two faces (21, 22); at least one heating element (40), adapted to be connected to a source of electricity to generate heat, comprising a stretch (41) arranged inside the wall (23), which extends along the wall (23), whereby the heat generated by the at least one heating element (40) can be transmitted to the body (20) and to the substance to be heated.

### FIELD OF THE INVENTION

The present invention relates to an electric heater for heating a substance, in particular a substance or solution comprising water and urea, contained in a tank of a motor vehicle. The tank and the aqueous solution comprising urea are used in particular to save fuel and reduce pollution of the motor vehicle.

### BACKGROUND ART

New technologies for saving fuel and reducing pollution in the automotive sector require tanks containing a liquid, particularly water, or an aqueous solution, such as an aqueous solution containing urea. The AdBlue® solution is an example of an aqueous solution comprising urea.

At low temperatures, e.g. about 0° C. for water and about −11° C. for some aqueous solutions, the liquid freezes and is therefore substantially unusable. The frozen mass must be thawed quickly and in precise quantities to ensure the correct operation of the vehicle.

For thawing, especially for relatively large masses, it is not possible to use heating systems with an excessively high power concentration. Indeed, excessive overheating causes the mass to pass from the solid state directly into the gaseous state, i.e. a sublimation occurs.

This implies the formation of a gas layer which does not allow an effective thawing of the remaining part of the mass to be thawed. Furthermore, the gas may affect the operation of the system connected to the tank, because such a system is designed to operate with a liquid.

The need is therefore felt to be able to heat a substance in a tank in a rapid and reliable manner.

### SUMMARY OF THE INVENTION

It is an object of the present invention to provide an electric heater capable of effectively and quickly thawing a frozen mass or substance, in particular an aqueous solution containing urea, contained in a tank.

In particular, it is one of the objects of the invention to thaw the aqueous solution containing urea which is inside the tank, avoiding its sublimation.

It is a further object of the present invention to provide such an electric heater which allows an optimal diffusion of heat.

It is a further object of the present invention to provide such an electric heater which can be manufactured easily and at low costs.

The present invention achieves at least one of such objects, and other objects which will become apparent in light of the present description, by means of an electric heater for heating, in particular thawing, an aqueous substance or an aqueous solution comprising urea inside a tank for saving fuel and reduce pollution of a motor vehicle, the electric heater comprising a thermally conductive body, provided with a wall which at least partially extends about an axis Z, comprising two opposite faces; a plurality of fins which extend transversally from at least one first face of said two faces; at least one heating element, adapted to be connected to a source of electricity to generate heat, comprising a stretch arranged inside the wall, which extends along the wall around said axis Z, whereby the heat generated by the at least one heating element can be transmitted to the body and to said substance or solution to be heated, in particular thawed.

In any case, the electric heater can be apt to heat another type of solution for saving fuel and reducing the pollution of a vehicle.

According to an aspect, the invention also comprises a tank for containing an aqueous solution comprising urea for saving fuel and reducing the pollution of a motor vehicle, the tank comprising at least one electric heater, in particular according to any of the claims 1 to 13.

According to an aspect, the invention also relates to a system for saving fuel and reducing pollution of a motor vehicle comprising an electric heater, in particular according to any one of the claims from 1 to 13 or a tank according to claim 14, 15 or 16.

Advantageously, by arranging the electric heater around the pump of the tank, the frozen mass is thawed in the zone needed to take the liquid from the tank.

Furthermore, the heat can be diffused as much as possible by conduction within the frozen mass. Indeed, the body or diffuser penetrates into the frozen mass, thus increasing the diffusion of heat by conduction. This aspect is particularly advantageous in view of the fact that conduction heating is more efficient and effective, particularly in terms of speed, with respect to convection and radiation, in order to achieve rapid thawing.

Preferably, said body is monolithic. Preferably, said body is obtained by die-casting by injection of material around said stretch of the at least one heating element which is inside said wall of the body.

Some further advantageous aspects of the electric heater are listed below, such as:
it has preferably a self-supporting structure, whereby it can be easily fixed to the flange of the injection module, which in turn can be fixed to the tank;
it is particularly adapted to heat a frozen mass subject to several freezing and thawing cycles;
it is particularly resistant to mechanical stresses, in particular to shocks and vibrations;
it preferably always produces the maximum available power;
it is preferably configured so as not to cause the substance to change to a gaseous state and to reach temperatures that do not deteriorate any plastic components;
it is made of materials suitable for contact with the liquid contained in the tank and can optionally be coated with polymer or ceramic material or other materials compatible with the liquid, e.g. coated with polytetrafluoroethylene, such as Teflon;
it is capable of operating at a voltage supplied by the car battery, for example at about 13 V.

Furthermore, the manufacturing process to obtain the electric heater, as well as the assembly of the electric heater with the tank, are advantageously easy to perform.

Preferably, the heating element is an sheathed resistor or a positive temperature coefficient (PTC) resistor. When additional heating elements are provided, the additional heating elements are also preferably armored resistors or of the PTC type. Optionally, the electric heater comprises only one heating element, i.e. only one element which produces heat by the Joule effect. Preferably, such a heating element is a sheathed electrical resistor.

Optionally, the electric heater does not comprise Joule heating elements of any other type than sheathed resistors.

Further features and advantages of the present invention will be more apparent in light of the detailed description of preferred, but not exclusive embodiments.

The dependent claims describe particular embodiments of the invention.

### BRIEF DESCRIPTION OF THE DRAWINGS

The description of the invention refers to the accompanying drawings, which are provided by way of non-limiting example, in which:

FIG. 1 shows a perspective view of an electric heater according to the invention;

FIG. 2 shows a perspective view of a component of the electric heater in FIG. 1;

FIG. 3 shows a perspective view of part of a tank provided with the electric heater in FIG. 1;

FIG. 4 shows a front view of the part of the tank in FIG. 3;

FIG. 5 shows a perspective view of the heater in FIG. 1 and some parts of the tank.

### The same references in the figures identify the same elements or components.

### DETAILED DESCRIPTION OF EXAMPLE EMBODIMENTS OF THE INVENTION

With reference to the Figures, it is described an electric heater 1, in particular to heat a substance inside a tank 100, e.g. a tank for a water-injection system.

In general, the electric heater 1 comprises a body 20 made of thermally conductive material, and at least one heating element 40.

The body 20 is provided with a wall 23, preferably only one wall, which at least partially or only partially extends around an axis Z. The axis Z is preferably a straight axis, preferably a central axis, defined by the body 20.

The wall 23 comprises two mutually opposite faces 21, 22, which are preferably the outer face and inner face of the wall 23, respectively.

The body 20 is also provided with a plurality of fins 24, 25 which extend transversally from at least one first face of said two faces 21, 22.

In particular, a plurality of fins 24 which extend from the face 21 and/or a plurality of fins 25 which extend from the face 22 of the wall 23 can be provided.

The face 22 and the respective fins 25, when provided, delimit an empty space. In particular, the entire space delimited by the face 22 is preferably empty. The heater 1 can therefore be arranged around a pump 101 of the tank 100, as will be further described.

Furthermore, the body 20 is open at the top and bottom.

Preferably, the body 20, in particular the wall 23 and the fins 24, 25, is made of metal, preferably aluminum or aluminum alloy. In general, the material of the body 20 can advantageously be chosen according to the substance with which it will come into contact. In particular, the material of the body 20 is chosen so that the body 20 can be immersed in water or an aqueous solution containing urea, and that it is not an electrical conductor or has a very low electrical conductivity, such as aluminum.

Optionally, the body 20 is coated with polymer or ceramic material, or in any case with a material compatible with the liquid. For example, the body 20 can be coated with polytetrafluoroethylene, e.g. Teflon®. By way of example, the entire body 20, comprising the fins 24 and/or 25, is coated with polymer or ceramic material.

Preferably, the wall 23 is monolithic and preferably the body 20 is monolithic. In particular, preferably, the wall 23 and the fins 24, 25 form a monolithic component, i.e. the fins 24, 25 are integral with the wall 23. In general, the body 20 is preferably obtained by die-casting. In particular, the body 20 is preferably obtained by die-casting by injection of material, in particular of the material of which body 20 is made, around the stretch 41 of the at least one heating element 40 which is inside the wall 23.

Advantageously, the body 20, especially the wall 23, is a self-supporting structure.

Preferably, the height, in particular the maximum height, of the wall 23 parallel to the axis Z is between 50 and 90 mm, e.g. between 60 and 80 mm. Such a height is preferably constant or substantially constant.

Preferably, the maximum height of the wall 23 corresponds to the maximum height of the body 20.

Preferably, the height of the fins 24, 25 parallel to the axis Z is lower than the height of the wall 23.

Preferably, the fins 24, 25 are spaced from the lower edge 26 and/or from the upper edge 27 of the wall 23.

Preferably, the fins 24 are equally spaced between each other and/or the fins 25 are equally spaced between each other.

Preferably, a fin 25 is provided at each fin 24. In particular, each fin 24 is optionally aligned with a respective fin 25, i.e. they are coplanar. Alternatively, the fins 24 and 25 can be mutually offset.

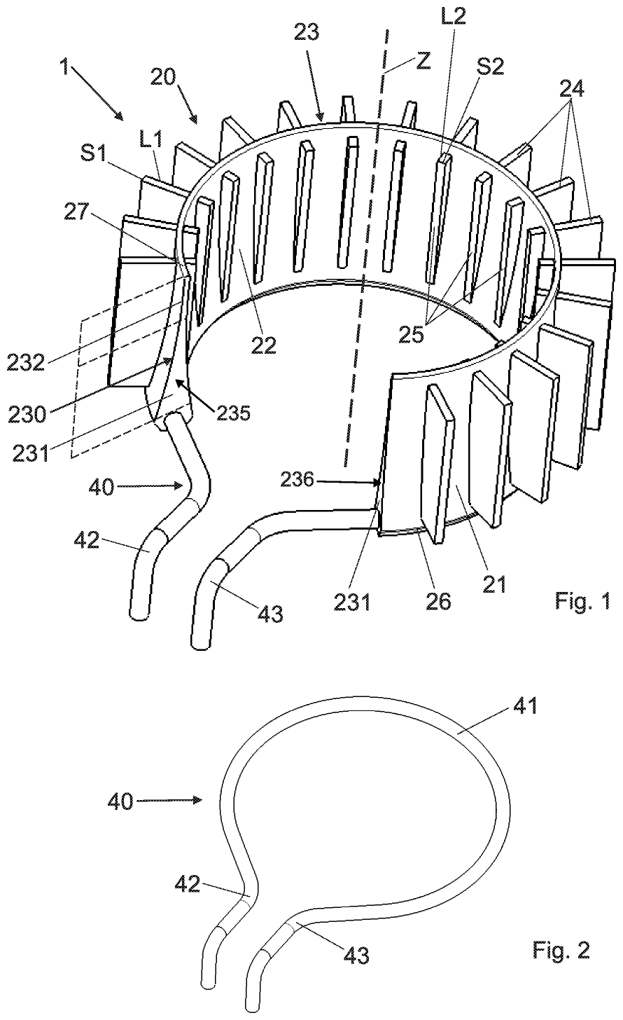

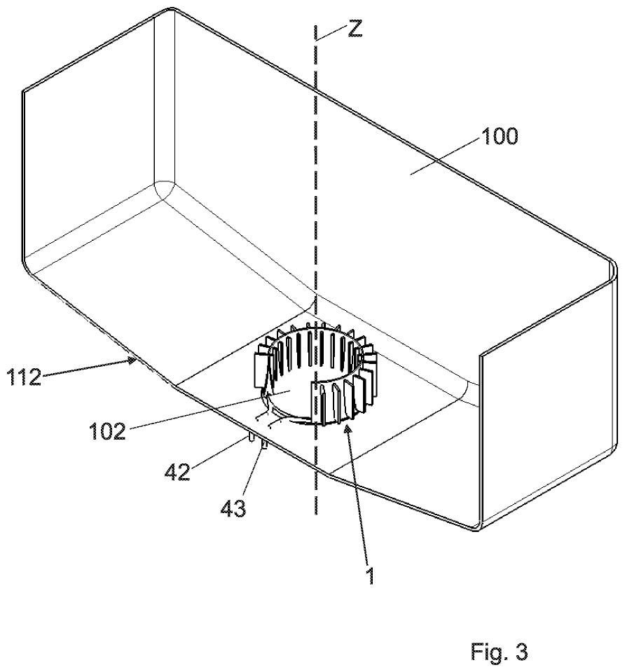

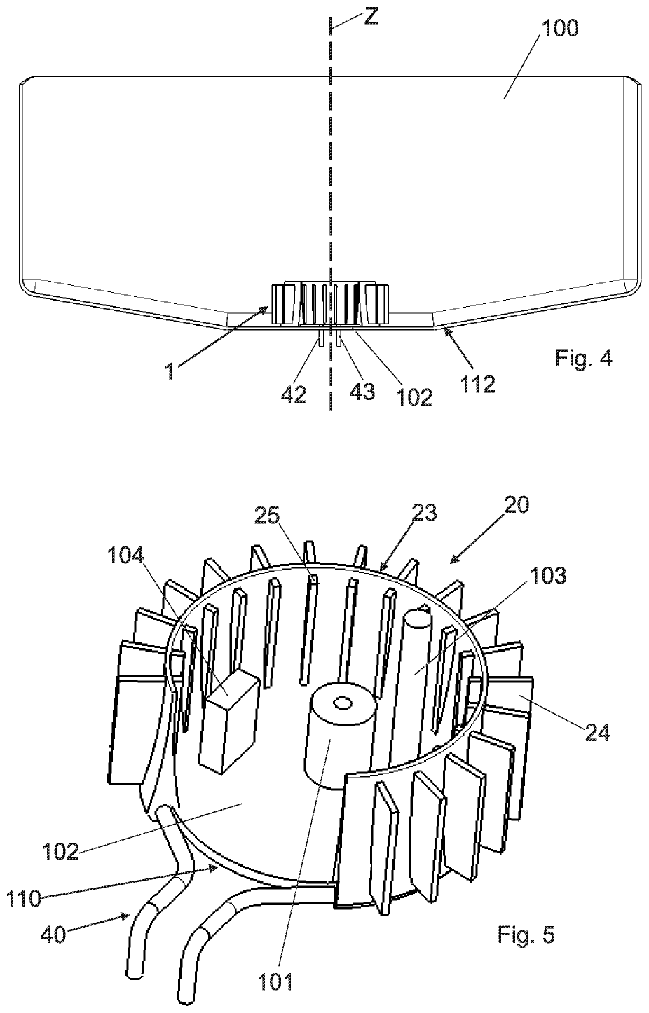

Preferably, the width “L1”, “L2” (FIG. 1), or radial extension, of each fin 24, 25 is between 2 and 20 mm. For each fin 24, 25, such a width is the extension along an axis perpendicular to the axis Z and to the respective face 21, 22 from which the fin 24, 25 extends.

The width L1, L2 of each fin 24, 25 can be either constant or variable.

Preferably, the width of the fins 24 and/or the fins 25 increases towards the upper edge 27 of the wall 23.

Preferably, the thickness “S1”, “S2” (FIG. 1) of each fin 24, 26 is between 1 and 10 mm.

For each fin 24, 25, such a thickness is perpendicular to the respective height and to the respective width and the height is parallel to the axis Z.

The thickness of each fin 24, 25 can be either constant or variable.

Preferably, the fins 24, 25 extend perpendicularly from the respective face 21, 22.

For example, as shown in the figures, the fins 24 extend radially outwards and the fins 25 extend radially inwards.

As mentioned above, the electric heater comprises at least one heating element 40.

The at least one heating element 40 is adapted to be connected to a source of electricity (not shown) to generate heat, in particular by Joule effect.

The least one heating element 40 comprises a stretch 41 (shown in FIG. 2), preferably a single stretch 41, which is arranged inside the wall 23, preferably completely inside the wall 23. In particular, such a stretch 41 is located inside and in contact, more in particular in direct contact, with the wall 23. The stretch 41 extends along wall 23, around the axis Z. The stretch 41 is substantially immersed in or surrounded by, in particular completely immersed in or surrounded by, the wall 23.

Therefore, the heat generated by the at least one heating element 40 can be transmitted to the body 20, which in turn transmits it to the substance to be heated.

In other words, the body 20 serves as a diffuser.

Preferably, the heating element 40 crosses the wall 23, so that two stretches 42, 43 of the at least one heating element 4, between which said stretch 41 extends, protrude from the wall 23. For example, the stretch 42 protrudes from the first end 235 of the wall 23 and/or the stretch 43 protrudes from the second end 236 of the wall 23. Preferably, the stretch 41 extends substantially on a single plane. In particular, the axis (preferably central) defined by the stretch 41, around which the outer wall or casing of the stretch 41 extends, extends substantially only on one plane. In other words, the stretch 41 is substantially flat. In particular, the stretch 41 does not form a winding. The electrical resistor 1 can therefore be easily made. Preferably, the stretch 41 is shaped as an open ring, i.e. it has an open annular shape.

Preferably, the electric heater 1, and in particular the body 20, is configured to avoid the passage to the gaseous phase of the substance to be heated. For example, the electric heater 1 is preferably configured so that the body 20 can reach a maximum temperature of about 90° C., e.g. 90° C.

Preferably, there is provided only one heating element 40, although further heating elements can be provided.

Preferably, the heating element 40 is an sheathed resistor. Preferably, such sheathed resistor comprises a casing containing at least one resistive element, such as a resistive wire. The casing, which is preferably tubular, is made of thermally conductive material, preferably metal, such as steel. The resistive element is preferably surrounded by or immersed in an electrically insulating material, e.g. magnesium oxide, contained in the casing.

Preferably, as mentioned, the stretch 41 extends between two stretches 42, 43, which protrude from the wall 23. In particular, the stretches 42, 43 are adjacent to the stretch 41. Such stretches 42, 43 are preferably folded, comprising at least one curved stretch, so as to be able to cross a wall of the tank 100, e.g. its bottom wall 112, as will be described below.

The ends of stretches 42 and 43 serve for the connection to the electrical power source.

The source of electricity to which the heating element 40 may be connected to generate heat is preferably the battery (not shown) of the motor-vehicle, which typically, but not exclusively, operates at a voltage of about 13 V.

Preferably, the heating element 40 is proximal to an edge, e.g. the lower edge 26, of the wall 23 and distal to the opposite edge, e.g. the upper edge 27, of the wall 23. Preferably, the stretch 41 of the heating element 40 is arranged inside the lower edge 26 of the wall 23.

Preferably, the wall 23 has a thickness, perpendicular to the axis Z, between 1 and 20 mm. The wall thickness 23 can be constant or variable. Preferably, the wall thickness 23 corresponds to the distance, in particular the minimum distance, along a direction orthogonal to the axis Z, between the face 21 and the face 22 of the wall 23.

Furthermore, optionally, the wall thickness 23 may have a portion with variable thickness and a portion with constant thickness. Preferably, the variable thickness portion has a height, parallel to the axis Z, greater than the height of the constant thickness portion.

Preferably, for a better heat distribution, all or part of the portion 230 of the wall 23 comprised between the stretch 41 and the upper edge 27 has a decreasing thickness towards the upper edge 27. For example, the maximum thickness of the portion 230, can be between 10 and 20 mm; and the minimum thickness of the portion 230 can be between 1 and 10 mm.

In the example shown, only one part 231 of the portion 230 has a decreasing thickness.

In this case, preferably, the part, or stretch, 232 of the portion 230, adjacent to the portion 231 has a constant thickness, preferably equal to the minimum thickness of the part 231. For example, the constant thickness of the part 232 has a value between 1 and 10 mm.

The portion 230 and its parts or sub-portions 231, 232 substantially are portions of height of the wall 23, which extend along the entire length of the wall 23 (the length is the dimension which at least partially extends around the axis Z). For illustrative purposes, in FIG. 1 the portion 230 and its parts 231, 232 are also indicated with dotted lines. The part 231 is distal with respect to the upper edge 27, and the part 232 is proximal to the upper edge 27 of the wall 23. More in detail, the part 232 comprises the upper edge 27.

Preferably, the lower edge 26 has a thickness, perpendicular to the axis Z, greater than the maximum thickness of the portion 230. Such a thickness of the lower edge 26 also comprises the dimension of the stretch 41 of the heating element 40.

Preferably, the height, or extension, parallel to the axis Z of the wall 23 between the outer face, i.e. the lower face, of the lower edge 26 and the stretch 41 has a value between 1 and 40 mm. In a particular, non-limiting example, such a height is between 1 and 5 mm. In another particular example, the stretch 41 extends over a plane which is approximately half the height of the entire wall 23.

Preferably, the entire wall 23 extends around the axis Z and the entire stretch 41 of the heating element 40 extends around the axis Z.

Preferably, but not exclusively, the wall 23 is shaped as a ring, preferably as an open ring, as shown in the figures, or alternatively is shaped as a closed ring.

When the wall 23 is shaped as an open ring, in particular, the wall 23 comprises two separate end surfaces 235, 236. The end surfaces 235, 236 are transversal, e.g. orthogonal, to the faces 21, 22.

In the scope of the ring shape, the wall 23 can optionally have one or more inlets facing outwards and/or inwards.

Preferably, the ring shape is such that the length, around the axis Z, of the wall 23 defines a curved axis, preferably an arc of a circle.

Preferably, the wall 23 has an inner diameter between 100 and 150 mm.

Preferably, the minimum distance, along an axis perpendicular to the axis Z, between any two opposite points of the face 22 of the wall 23 is between 100 and 150 mm.

Preferably, the stretch 41 of the heating element 40 defines a curvilinear axis which is substantially parallel to the curvilinear axis of wall 23.

Preferably, the curvilinear axis of the stretch 41 lies in a plane perpendicular to the axis Z. Preferably, the curvilinear axis of stretch 41 lies completely on said plane perpendicular to the axis Z.

The invention also comprises a tank 100, partially shown, to contain a substance, in particular a substance comprising water. The tank 100 is provided with at least one electric heater 1, preferably only one electric heater 1, arranged inside it.

The 100 tank is preferably made of plastic, e.g. polyethylene.

The tank 100 is preferably the tank of a motor vehicle. In particular, the tank 100 is adapted to contain a liquid, e.g. water or an aqueous solution, e.g. such as a substance or an aqueous solution comprising urea. The tank 100 is preferably adapted to be connected to a system (not shown) for saving fuel and reducing pollution of the motor vehicle, e.g. a system called water-injection.

Preferably, the tank 100 comprises an injection module 110. The injection module 110 comprises a support or flange 102, with which the pump 101 for the liquid is associated, in particular to which the pump 101 is fixed. Preferably, the pump 101 crosses the flange 102. The pump 101 or pumping device is used to draw the liquid from the tank 100. The pump 101 is diagrammatically shown in FIG. 5.

For example, the flange 102 is a base support, preferably substantially flat.

The flange 102 is preferably made of plastic, e.g. high-density polyethylene (HDPE). The flange 102 is fixed to the tank 100, e.g. to the bottom wall 112 of the tank 100. In particular, such a bottom wall 112 preferably has an opening which is closed by the flange 102. The flange 102 and the bottom wall 112 are preferably fixed to each other by welding, e.g. ultrasonic welding, gluing or interlocking.

Preferably, the flange 102 is fixed internally to the tank 100.

The electric heater 1 is preferably fixed to the flange 102 which, as described above, is fixed in turn to the tank 100.

In particular, the lower edge 26 of the body 20, more in particular the lower surface (or outer face) of the lower edge 26, is preferably fixed to the flange 102 of the injection module 110. The fixing is preferably a mechanical fixing, e.g. by interlocking, or by gluing. Preferably, the wall 23 rises vertically from the flange 102, i.e. it is preferable that the axis Z is substantially perpendicular to the flange 102. The assembly comprising the injection module 110 and the heater 1 is shown in FIG. 5.

Preferably, the bottom wall 102 of the tank 100 comprises two side portions between which a central portion extends, to which the injection module 110 is fixed, and thus also the electric heater 1. The side portions are inclined so as to form an obtuse angle of less than 180° inside the tank 100 with the central portion.

Preferably, the outer casing of the pump 101 is made of plastic, e.g. polyethylene.

Preferably, the pump 101 is arranged in a central zone of the bottom wall 112. Advantageously, the electric heater 1 is arranged around the pump 101. More in particular, the pump 101 is arranged in the space defined by the inner face 22 of the wall 23. Thereby, the frozen mass which is near the pump 101 can be thawed, so that the liquid can be effectively drawn from the tank 100.

More in particular, the axis of the pump 101 is preferably near to or coincides with the axis Z defined by the electric heater 1.

Optionally, a liquid level sensor 103 and/or a further sensor 104, e.g. a temperature sensor, are also located in the space delimited by the inner face 22 of the wall 23.

Both sensors 103, 104 are diagrammatically shown in FIG. 5 and are preferably part of the injection module 110, e.g. being fixed to the flange 102.

Preferably, the height of the wall 23 from the flange 102 is higher than the height of the pump 101 from the flange 102.

Preferably, the fins 24, 25 are spaced by the flange 102.

Preferably, the stretches 42, 43 of the heating element cross the bottom wall 112, so that their ends are outside the tank 100.

The zones of the bottom wall 112 crossed by the stretches 42, 43 are appropriately sealed to prevent the liquid from escaping.

According to an aspect, the invention also relates to a process, in particular a die-casting process, to obtain an electric heater 1, wherein there is provided a step of injecting material around said stretch 41 of at least one heating element 40 to obtain the body 20.

According to an aspect, the invention also relates to a system for saving fuel and reducing pollution of a motor vehicle comprising an electric heater 1 or a tank 100.

1. An electric heater for heating, an aqueous solution comprising urea inside a tank to save fuel and reduce pollution of a motor vehicle, the electric heater comprising
a thermally conductive body, provided with a wall (23) which at least partially extends around an axis, comprising two opposite faces;
a plurality of fins which extend from at least one first face of said two faces;
at least one heating element, adapted to be connected to a source of electricity to generate heat,comprising a stretch arranged inside the wall, which extends along the wall around the said axis, wherein the heat generated by the at least one heating element can be transmitted to the thermally conductive body which can transmit the heat to a solution to be heated;
wherein said stretch of the heating element defines a curvilinear axis; wherein the curvilinear axis defined by said stretch lies completely in a plane perpendicular to the said axis.

2. The electric heater according to claim 1, wherein said stretch of the at least one heating element is proximal to a lower edge of the wall and distal with respect to an upper edge of the wall, or wherein said stretch of the at least one heating element is arranged at about half the height of the wall along said axis.

3. The electric heater according to claim 2, wherein said stretch of the at least one heating element is arranged in the lower edge of the wall.

4. The electric heater according to claim 1, wherein said wall has an annular, preferably open annular, shape.

5. The electric heater according to claim 1, wherein the thickness of said wall, perpendicular to said axis, is between 1 and 20 mm; and/or wherein the height of said wall, parallel to said axis, is between 50 and 90 mm.

6. The electric heater according to claim 1, wherein a portion of the wall which extends between the stretch and an upper edge of the wall at least partially has a decreasing thickness towards the upper edge, and preferably has an end stretch comprising the upper edge and having a constant thickness.

7. The electric heater according to claim 1, wherein there is provided only one heating element.

8. The electric heater according to claim 1, wherein said al. least gag heating element is a sheathed resistor, and preferably wherein said stretch extends between two stretches of said at least one heating element which protrude from said wall.

9. The electric heater according to claim 1, wherein fins of said plurality of fins extend both from the first face and from a second face of said two opposite faces.

10. The electric heater according to claim 1, wherein the body is made of metal, preferably aluminum or aluminum alloy.

11. The electric heater according to claim 1, wherein the body is coated with polymer or ceramic material, preferably polytetrafluoroethylene.

12. The electric heater according to claim 1, configured so that the body can reach a maximum temperature of about 90° C.

13. The electric heater according to claim 1, wherein an axis around which an outer part of said stretch extends, substantially extends on a single plane and/or wherein said stretch has an open annular shape.

14. A tank for containing an aqueous solution comprising urea for saving fuel and reducing pollution of a motor vehicle, the tank comprising therein at least one electric heater according to claim 1.

15. The tank according to claim 14, wherein said at least one electric heater is fixed to an inner wall of the tank, preferably said inner wall being a bottom wall of the tank.

16. The tank according to claim 14, comprising a pumping device for the solution, wherein the electric heater is arranged around said pumping device.

17. A system for saving fuel and reducing pollution of a motor vehicle comprising an electric heater according to claim 1.

18. The electric heater according to claim 1, wherein said curvilinear axis defined by said stretch is substantialiy parallel to a curvilinear axis of said wall.
